(19) United States
(12) Patent Application Publication
(10) Pub. No.: US 2011/0225012 A1
(43) Pub. Date: Sep. 15, 2011

(54) System and Method of Travel Itinerary Creation

(75) Inventors: Bryan William Harwood, Denver, CO (US); Luke Alfred Vassallo, Sydney (AU)

(73) Assignee: Travelport, LP, Atlanta, GA (US)

(21) Appl. No.: 12/721,920

(22) Filed: Mar. 11, 2010

(51) Int. Cl. G06Q 50/00; G06Q 10/00

(52) U.S. Cl. 705/6; 705/5

(57) ABSTRACT

A system and method for creating a travel itinerary. An itinerary creation engine may receive a request for a travel itinerary, identify one or more midpoints between the requested origin and destination (or proximate locations), and generate an itinerary that includes a route between the one or more midpoints and the origin or the destination (or proximate locations).

### TECHNICAL FIELD

Embodiments described herein relate to the field of travel, particularly, to the creation of travel itineraries.

### BACKGROUND

In a traditional travel shopping transaction, a shopper provides their travel criteria to a shopping system, which may access various sources of travel data, such as a Global Distribution System (GDS), and return potential travel itineraries based on the shopper's travel criteria. Often, however, in the case of conveyances (e.g., air, rail, etc.), these itineraries lack robustness because the shopping system offers limited routes or providers. A shopper may thus miss the opportunity to price and book a more preferable itinerary.

### BRIEF DESCRIPTION OF THE DRAWINGS

Embodiments are illustrated by way of example, and not limitation, in the figures of the accompanying drawings in which:

FIG. 1 is a block diagram of a system incorporating one embodiment.

FIG. 2 is a network diagram of a system incorporating one embodiment.

FIG. 3 is a network diagram of a system incorporating one embodiment.

FIG. 4 is a flowchart of certain operations according to one embodiment.

FIG. 5 is a flowchart of certain operations according to one embodiment.

FIG. 6 is a depiction of the results of a query for available midpoints according to one embodiment.

FIG. 7 is a flowchart of certain operations according to one embodiment.

### DETAILED DESCRIPTION

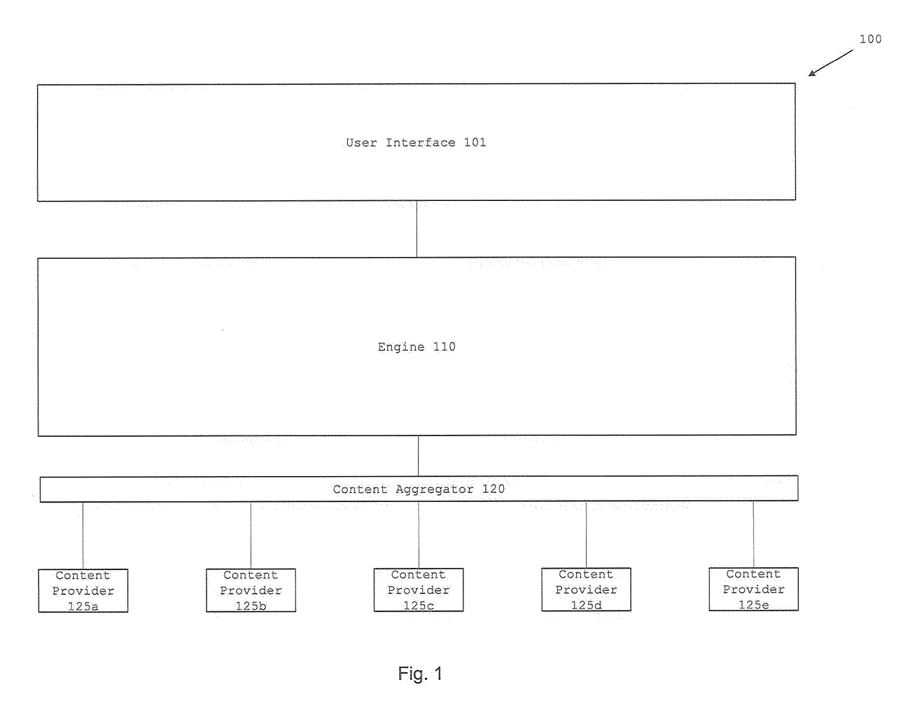

FIG. 1 is illustrative of a computer system 100 that may be employed in an embodiment of the invention. The computer system 100 may comprise a computer-implemented itinerary creation engine 110 in communication with user interface 101, content aggregator 120, and one or more content providers 125a-125e of travel inventory data.

Itinerary creation engine 110 may comprise hardware, such as a RISC processor, or software executed on hardware such as a desktop computer, server, server farm or other computing device. Content aggregator 120, likewise, may be implemented in a variety of configurations of hardware or software executed on hardware. User interface 101 may be implemented on a number of common computer interfaces such as a GUI, terminal, client, cell phone or other mobile device. Content providers 125a-125e may be any source of travel inventory data. Such travel inventory data may include, for example, fares, schedules, routes and seating arrangements and availability. Content providers 125a-125e may be global distribution systems (GDS), computer reservation systems (CRSs), or other content hubs, some of which may contain aggregated travel inventory data from other content providers.

The composition and configuration of computer system 100 may reflect a variety of physical and logical arrangements and may utilize communication protocols and environments appropriate for such arrangements. Communications and interactions between the components of computer system 100 may be synchronous or asynchronous.

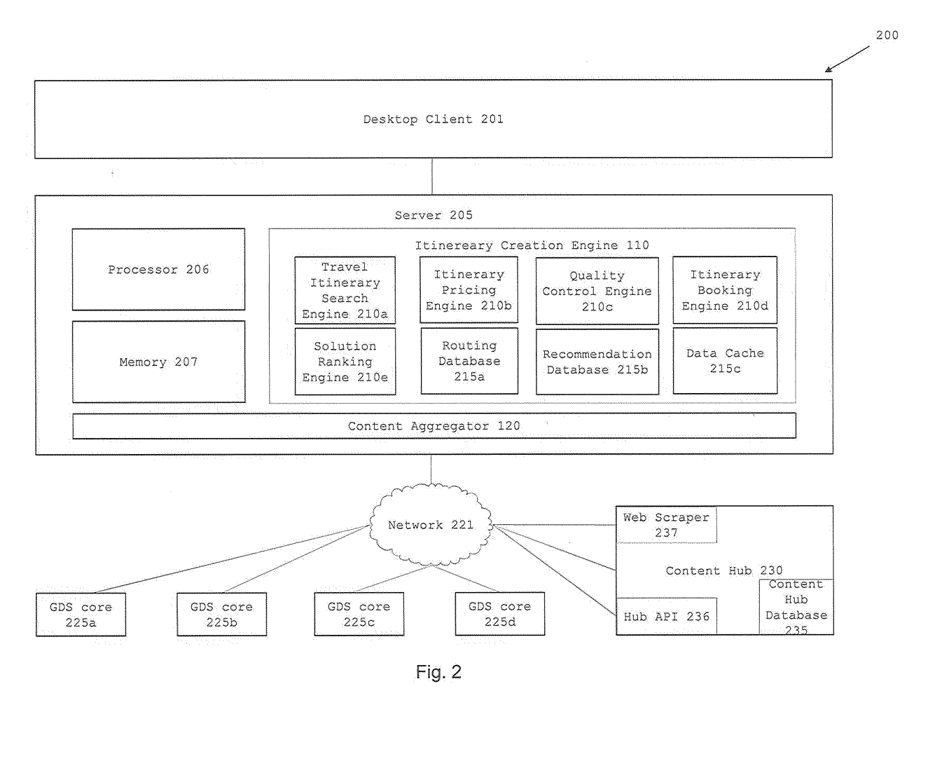

In the embodiment illustrated in FIG. 2, for example, server 205, comprising processor 206 and memory 207, executes itinerary creation engine 110, which comprises travel itinerary search engine 210a, itinerary pricing engine 210b, quality control engine 210c, itinerary booking engine 210d, solution ranking engine 210e, routing database 215a, recommendation database 215b, and data cache 215c. Routing database 215a may comprise routing data, such as origins, destinations, midpoints, and scheduling for routes operated by various conveyance providers. Recommendation database 215b may comprise travel itineraries previously booked or reserved by users of computer system 200. Server 205 may also execute content aggregator 120 in the form of an API.

Server 205 may be in communication with desktop client 201 (or any other appropriate user interface) and with GDS cores 225a-225d and content hub 230 over communications network 221.

Content hub 230 of the embodiment of FIG. 2 may be any computing device comprising a content hub database 235 of travel inventory data, such as for direct carriers. Direct carriers may be any travel conveyance provider that does not participate or only participates in a limited capacity with a GDS. Content hub 230 may also comprise one or more adapters, which may be in the form of hub API 236 and web scraper 237, to obtain travel inventory data from other content providers over communications network 221. Content hub 230 may store travel inventory data obtained from operations performed by hub API 236 and web scraper 237 in content hub database 235.

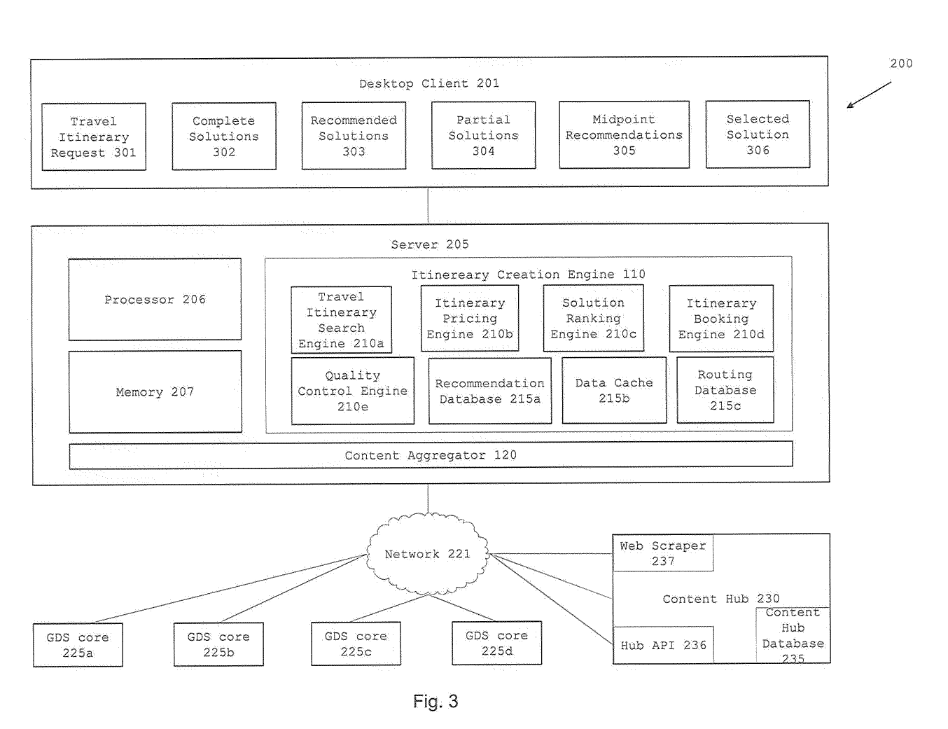

In the embodiment reflected in FIG. 3, desktop client 201 facilitates the receipt or transmission of travel itinerary request 301, complete solutions 302, recommended solutions 303, partial solutions 304, midpoint recommendations 305, and selected solution 306. A user may initiate use of computer system 200 by submission of travel itinerary request 301 comprising itinerary criteria, including an origin and destination, to the itinerary creation engine 110 via desktop client 201.

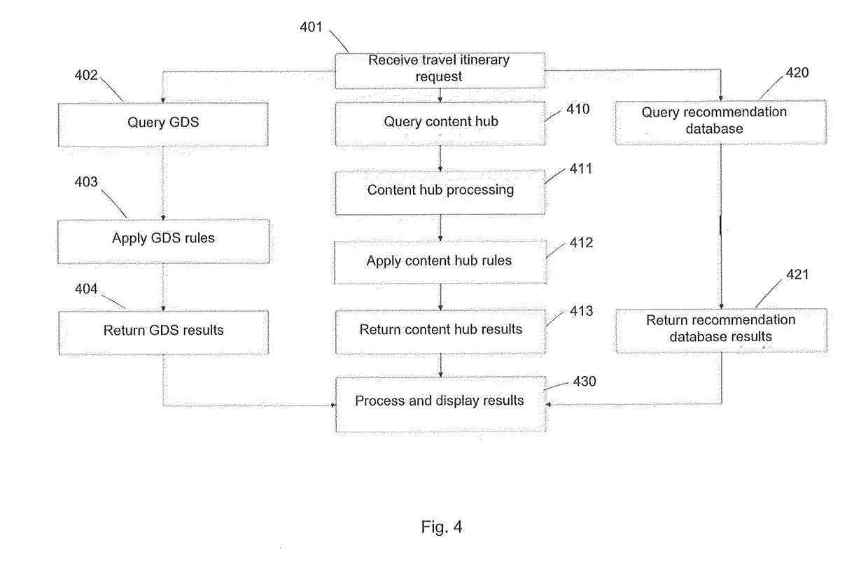

FIG. 4 illustrates an embodiment of the process that provides complete solutions 302 and recommended solutions 303 in response to travel itinerary request 301. Complete solutions 302 may be itineraries that comprise conveyance information, including connections, if any, between the origin, or a location proximate to the origin, and the destination, or a location proximate to the destination. Recommended solutions 303 may be itineraries that are based, at least in part, on feedback from or prior activities of users, and that comprise conveyance information, including connections, if any, between the origin, or a location proximate to the origin, and the destination, or a location proximate to the destination. In step 401, travel itinerary request 301 is received from a user. Travel itinerary request 301 may further comprise other itinerary criteria such as price or time. In step 402, travel itinerary search engine 210a may utilize content aggregator 120 to query GDS cores 225a-d for potential complete solutions to travel itinerary request 301. In step 403, GDS cores 225a-d may process the results of the query based on internal GDS core processing rules. Internal GDS core processing rules may be set by the GDS core operator and may reflect any variety of parameters or conditions to apply to processing, such as prioritization, filtering, and scope. In step 404, GDS cores 225a-d may return the processed results to itinerary search engine 210a.

In step 410, travel itinerary search engine 210a may query content hub 230 via content aggregator 120. In step 411, content hub 230 may process the query and, in step 412, may apply internal rules to the query results. Content hub rules, like internal GDS core processing rules, may be defined by the content hub operator and reflect a variety of parameters or conditions for processing data. Content hub 230 may, in step 413, return results, based on either retrieved content, via hub API 236 and web scraper 237, or local content derived from content hub database 235, to travel itinerary search engine 210a.

In step 420, travel itinerary search engine 210a may query recommendation database 215a via solution ranking engine 210c for potential solutions to travel itinerary request 301. Solution ranking engine 210c may utilize various rules, algorithms, criteria or heuristics (e.g., price, travel time, carbon emission, rankings, etc.) to identify and obtain optimal potential solutions from recommendation database 215a. If qualified results are found, solution ranking engine 210c may forward the results to itinerary search engine 210a at step 425.

At step 430, itinerary search engine 210a may process the received results and transmit, asynchronously or synchronously, the results as potential complete solutions 302 and recommended solutions 303 for display to the user. Complete solutions 302 may comprise the results obtained from GDS cores 225a-d and content hub 230. Recommended solutions 303 (which may also be referred to as “Expert-Generated Recommendations”) may comprise the results obtained from recommendation database 215a.

Itinerary search engine 210a may process results in various ways. Such processing may simply prepare results for display, such as data formatting or arrangement. Alternatively, itinerary search engine 210a may cooperate with solution ranking engine 210e to filter, order or arrange complete solutions 302 and recommended solutions 303 based on various criteria, which may include criteria reflected by travel itinerary request 301. In another embodiment, itinerary search engine 210a may determine pricing and availability for complete solutions 302 or recommended solutions 303 utilizing itinerary pricing engine 210b. Itinerary pricing engine 210b may obtain pricing and availability information by accessing the appropriate content provider via content aggregator 120.

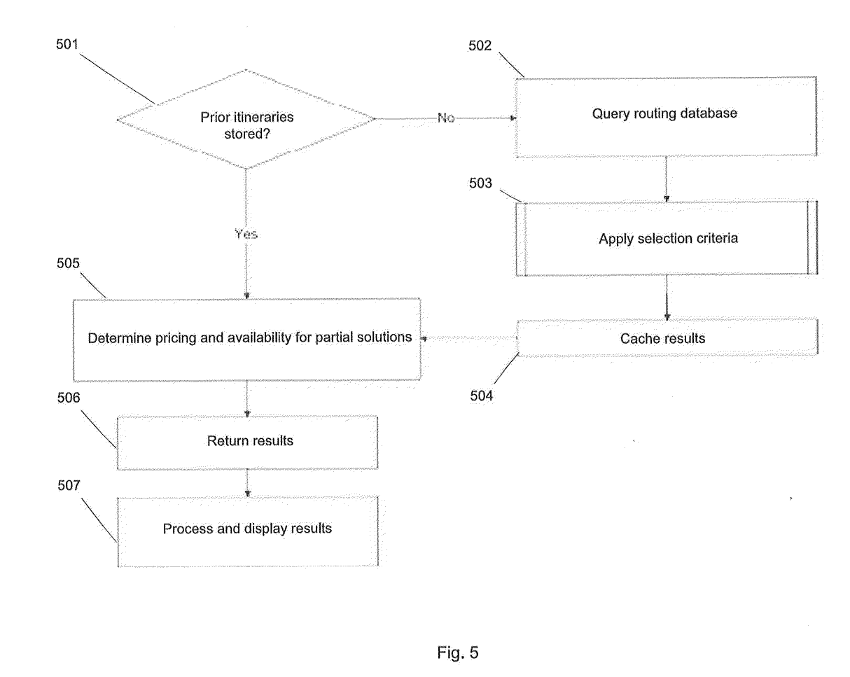

FIG. 5 illustrates an embodiment of the invention in which partial solutions 304 may be returned in response to travel itinerary request 301. Partial solutions 304 are itineraries that comprise conveyance information between one or more midpoints and the origin or locations proximate to the origin, or the destination or locations proximate to the destination. In step 501, itinerary search engine 210a may query the data cache 215b to determine if itineraries that may qualify as partial solutions to travel itinerary request 301 are stored from prior operations of computer system 200. If there are no such cached itineraries, itinerary search engine 210a, in step 502, may query routing database 215c to obtain available midpoints between the origin, or a location proximate to the origin, and the destination, or a location proximate to the destination, of travel itinerary request 301. In step 503, itinerary search engine 210a, may apply selection criteria such as internal heuristics or itinerary criteria from travel itinerary request 301 to determine optimal midpoints from the available midpoints and generate an optimal travel itinerary. In step 504, the results produced by itinerary search engine 210a may be cached in data cache 215b.

In step 505, itinerary search engine 210a may interact with itinerary pricing engine 210b to determine pricing and availability for the travel itineraries obtained from step 501 or step 504. Itinerary pricing engine 210b may obtain pricing and availability information by accessing the appropriate content provider via content aggregator 120. In step 506, itinerary pricing engine 210b may return pricing and availability data to itinerary search engine 210a.

In step 507, itinerary search engine 210a may process the received results and transmit, asynchronously or synchronously, the results as partial solutions 304 for display.

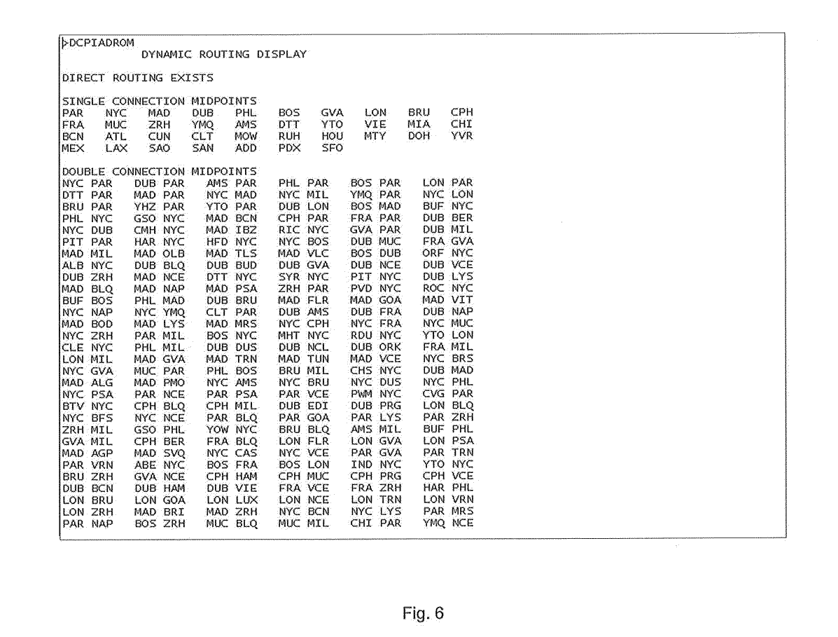

In another embodiment, itinerary search engine 210a may also interact with routing database 215a to identify midpoint recommendations 305, comprising midpoints between the origin of travel itinerary request 301, or locations proximate to the origin, and the destination of travel itinerary request 301, or locations proximate to the destination. Such midpoints may be used to construct alternative itineraries to partial solutions 304. Routing database 215a may respond with available midpoints in the form of ordered single connection and double connection midpoints. Such a response is illustrated in FIG. 6 for a request for travel from Washington, D.C. to Rome, Italy, specifically from the airports of Washington Dulles (IAD) and Leonardo da Vinci International (FCO).

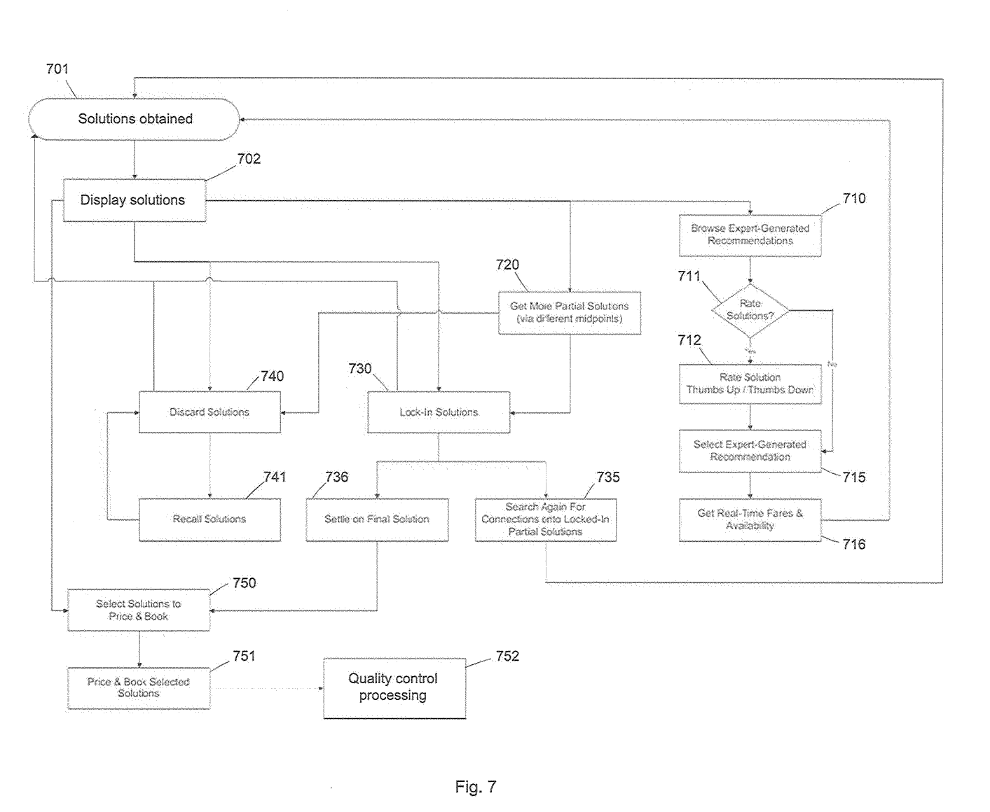

In the embodiment reflected in FIG. 7, at step 701, itinerary search engine 210a may obtain various solutions for travel itinerary request 301 and at step 702 transmit those solutions for display on desktop client 201.

At step 710, the user may choose to browse Expert-Generated Recommendations and at step 711, may have the option of providing user feedback regarding the proffered Expert-Generated Recommendations. If the user does not have the option or does not desire to provide user feedback, the user may, at step 715, select certain Expert-Generated Recommendations for real-time pricing and availability in step 716. Alternatively, the user may, at step 712 provide feedback regarding the proffered Expert-Generated Recommendations, such as through a “thumbs up/thumbs down” rating system. The solution ranking engine 210e may use such feedback as a basis for obtaining Expert-Generated Recommendations in step 420 or 421. After feedback is provided, the selected Expert-Generated Recommendations are checked for pricing and availability per steps 715 and 716, respectively.

At step 720, the user may select one or more of midpoint recommendations 305, which will cause itinerary search engine 210a to initiate generation of a new potential partial solution that includes the selected midpoint(s) from midpoint recommendations 305.

At steps 730 and 740, the user may communicate to the itinerary search engine 210a the user's desire to respectively select, or “lock-in” a proposed solution, or discard a proposed solution. If a user elects to discard a proposed solution from the display, the user may have the option of recalling the proposed solution immediately or at a later point in time at step 741. At either step 730 or step 740, a user may revise or resubmit travel itinerary request 301 to obtain new or additional complete solutions 302, recommended solutions 303, or partial solutions 304, and proceed with the process again from step 701.

At step 735, a new search may be initiated to obtain connections that, in combination with one or more of locked-in partial solutions 304, form an additional potential complete solution 302 for travel itinerary request 301.

The steps beginning at step 701 may be repeated until such a time that step 736 is reached and selected solution 306 is chosen, at step 750, for pricing and booking. At step 751, itinerary pricing engine 210b may price selected solution 306 and itinerary booking engine 210d maybook selected solution 306 by routing selection solution 306 or pertinent information regarding selection solution 306 to the appropriate content provider via content aggregator 120. Step 750 may have followed step 702 had a suitable solution been presented at step 702.

At step 752, certain itinerary data regarding selected solution 306 may be analyzed by quality control engine 210c for inclusion in the recommendation database 215b. Such analysis may account for a variety of pre-defined or real-time criteria, such as price, value or profitability.

What is claimed is:

1. An itinerary creation engine comprising:
a processor; and
a memory;
wherein said itinerary creation engine is programmed to:
receive a travel itinerary request, said travel itinerary request comprising an origin and a destination;
query a database for one or more routing midpoints between a first location at or proximate to the origin and a second location at or proximate to the destination;
query a content provider for conveyance information between the one or more routing midpoints and the first location or the second location;
transmit, for display on a user interface, a travel itinerary comprising the conveyance information.

2. The itinerary creation engine of claim 1, wherein the content provider comprises a computer reservation system.

3. The itinerary creation engine of claim 1, wherein the itinerary creation engine is further programmed to:
select one or more optimal routing midpoints from the one or more routing midpoints based upon selection criteria; and
wherein the content provider query is for conveyance information between the one or more optimal routing midpoints and a first location at or proximate to the origin or a second location at or proximate to the destination.

4. The itinerary creation engine of claim 3, wherein the selection criteria comprises travel time.

5. The itinerary creation engine of claim 3, wherein the itinerary creation engine is further programmed to:
query a second database for a second travel itinerary, wherein said second travel itinerary is a travel itinerary, between the origin, or a location proximate to the origin, and the destination, or a location proximate to the destination, that was booked prior to the receipt of the travel itinerary request; and
transmit, for display on a user interface, the second travel itinerary.

6. The itinerary creation engine of claim 5, wherein the itinerary creation engine is further programmed to:
receive a travel itinerary selection, wherein the travel itinerary selection comprises a selection of one or more of the transmitted itineraries.

7. The itinerary creation engine of claim 6, wherein the itinerary creation engine is further programmed to:
route the travel itinerary selection for booking; and
store final travel itinerary data, wherein the final travel itinerary data is based upon the travel itinerary selection.

8. The itinerary creation engine of claim 7, wherein the itinerary creation engine is further programmed to transmit or query asynchronously.

9. A computer-implemented method comprising:
receiving a travel itinerary request, said travel itinerary request comprising an origin and a destination;
querying a routing database for one or more routing midpoints between a first location at or proximate to the origin and a second location at or proximate to the destination;
selecting one or more optimal routing midpoints from the one or more routing midpoints based upon selection criteria;
querying a content provider for conveyance information between the one or more optimal routing midpoints and the first location or the second location; and
transmitting, for display on a user interface, a travel itinerary comprising the conveyance information.
querying a second database for a second travel itinerary, wherein said second travel itinerary is a travel itinerary, between the origin, or a location proximate to the origin, and the destination, or a location proximate to the destination, that was booked prior to receipt of the travel itinerary request; and
transmitting, for display on a user interface, the second travel itinerary;
receiving a travel itinerary selection, wherein the travel itinerancy selection comprises a selection of one or more of the transmitted itineraries;
routing the travel itinerary selection for booking; and
storing final travel itinerary data, wherein the final travel itinerary data is based upon the travel itinerary selection.

10. A computer-readable medium comprising instructions executable by a computer, wherein the instructions enable the computer to perform a method comprising:
receiving a travel itinerary request, said travel itinerary request comprising an origin and a destination;
querying a routing database for one or more routing midpoints between a first location at or proximate to the origin and a second location at or proximate to the destination;
selecting one or more optimal routing midpoints from the one or more routing midpoints based upon selection criteria;
querying a content provider for conveyance information between the one or more optimal routing midpoints and the first location or the second location; and
transmitting, for display on a user interface, a travel itinerary comprising the conveyance information.
querying a second database for a second travel itinerary, wherein said second travel itinerary is a travel itinerary, between the origin, or a location proximate to the origin, and the destination, or a location proximate to the destination, that was booked prior to receipt of the travel itinerary request; and
transmitting, for display on a user interface, the second travel itinerary;
receiving a travel itinerary selection, wherein the travel itinerary selection comprises a selection of one or more of the transmitted itineraries;
routing the travel itinerary selection for booking; and
storing the final travel itinerary data, wherein the final travel itinerary data is based upon the travel itinerary selection.
